(19) United States
(12) Patent Application Publication
(10) Pub. No.: US 2026/0318132 A1
(43) Pub. Date: Oct. 15, 2026

(54) Restrictor System for a Double-Hung Window

(71) Applicant: John Evans' Sons LLC, Landsdale, PA (US)

(72) Inventor: John R. Kunz, Douglassville, PA (US)

(21) Appl. No.: 19/176,132

(22) Filed: Apr. 10, 2025

(51) Int. Cl. E05C 17/02

(52) U.S. Cl. CPC E05C 17/02

(57) ABSTRACT

A system and method of restricting the movement of a window sash. A restrictor is mounted in the guide track of a window assembly. The restrictor has a flat section at one end and a flexible arm that extends away from the flat section as a cantilever. A locking protrusion extends from the flexible arm. The flexible arm biases the locking protrusion toward the window sash. As the window sash is opened, the locking protrusion engages an element on the window sash. The engaged element is preferably part of a counterbalance system. The locking protrusion engages the element on the window sash and prevents the window sash from reaching the fully open position until the locking protrusion is manually disengaged.

### BACKGROUND OF THE INVENTION

### 1. Field Of The Invention

In general, the present invention relates to restrictor devices that are used to limit the degree that a window sash can be opened. More particularly, the present invention system relates to the structure of the restrictor and how the restrictor interacts with other components of a double-hung window assembly.

### 2. Prior Art Description

One of the most common type of window is the double-hung window. Double-hung windows are the window of choice for most home construction applications. A double-hung window consists of an upper window sash and a lower window sash. Typically, a double-hung window assembly consists of a window frame and a pair of window sashes. The lower sash is inside the upper sash so that the sashes overlap and vertically slide parallel to each other along guide rails of the window frame. Either the upper window sash or the lower window sash can be selectively opened and closed by a person sliding the sash up and down within the window frame.

Double-hung windows use counterbalance systems to help support the weight of a sash when a sash of the window is moved to an open position. The counterbalance system holds the open window sash in place and prevents the window sash from moving under the force of its own weight. There are multiple counterbalance systems that are used on double-hung window. The counterbalance system used by a manufacturer usually depends upon the size of the window sashes, the construction style of the window frame and whether or not the window sashes are designed to tilt-in for cleaning. The use of multiple types of counterbalance system makes it difficult to design any type of restrictor that is designed to interact with the counterbalance system of a window.

Restrictors are the name given to a class of products that are designed to limit degree to which a window sash can be opened. Restrictors are often used in homes that have small children. Restrictors prevent a window from being opened beyond a few inches. This eliminates the danger of a child falling through a partially opened window. Restrictors are also often used in tall buildings and hotels to inhibit people from opening a window too wide and creating a fall or dropping danger.

The most popular type of restrictor is a locking tab that mounts on the face of the upper sash about four inches above the lower sash. Such restrictors can be extended, therein preventing the lower sash from being raised more than four inches or preventing the upper sash from being lowered more than four inches. Such restrictor systems are exemplified in U.S. Patent No. 8,776,440 to Sopkowiak, U.S. Patent Application Publication No. 2021/0404228 to Derham, and China Patent No. 101012720.

There are two primary problems associated with restrictors that mount to the face of the upper sash. The first problem is that the restrictors are highly visible on the face of the upper sash. This detracts from the aesthetics of the window. Furthermore, this positioning makes it easy for a person or child to engage and disable the restrictors. Once the restrictors are disabled, the window can be readily opened.

The second problem associated with restrictors on the face of a top window sash is that the restrictors are only accessible by a person inside the building. Accordingly, only a person inside a building has the ability to disengage the restrictors and open the window fully. This prevents the homeowner or emergency personnel from entering the window from the outside during an emergency.

Furthermore, some local and state building codes require that restrictors, if used, have the ability to be disengaged by a person outside the building.

A need therefore exists for an improved window sash restrictor that is aesthetically pleasing, non-obvious to a child and accessible from both sides of the window. This need is met by the present invention as described and claimed below.

### SUMMARY OF THE INVENTION

The present invention is a system and method of restricting the movement of a window sash in a guide track of a window assembly. A restrictor is provided that is mounted in the guide track of the window assembly. The restrictor is a molded body of plastic having a flat section at one end and a flexible arm that extends away from the flat section as a cantilever. The flexible arm has a curved segment that extends from the flat section and a straight segment that is suspended in the air. A locking protrusion extends from the flexible arm at a point between the curved segment and the straight segment.

The restrictor is mounted in the guide track, wherein the flexible arm biases the locking protrusion toward the window sash. As the window sash is opened from a closed position, the locking protrusion engages the element on the window sash. The engaged element can be a feature in or on the window sash but is preferably part of the counterbalance system used within the window assembly. As the window sash is moved in the guide track from a fully closed position toward a fully open position, the locking protrusion engages the element on the window sash and prevents the window from reaching the fully open position.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 shows a perspective view of a double-hung window assembly containing the present invention restrictor system;

FIG. 2 is a front view of the double-hung window assembly shown in FIG. 1;

FIG. 3 is an exploded fragmented view of a restrictor and a segment of the guide track in the window frame that holds the restrictor;

FIG. 4 is an assembled cross-sectional view of the segment shown in FIG. 3;

FIG. 5 shows a cross-sectional view of the segment of FIG. 3 with the window sash in a closed position and the restrictor unengaged;

FIG. 6 shows a cross-sectional view of the segment of FIG. 3 with the window sash in a partially open position and the restrictor fully engaged;

FIG. 7 shows a cross-sectional view of the segment of FIG. 3 with the window sash in a partially open position and the restrictor being disengaged by manual manipulation;

FIG. 8 shows a cross-sectional view of the segment of FIG. 3 with the window sash in a partially open position being moved towards a closed position;

FIG. 9 illustrates the interaction between the restrictor and a spring mount counterbalance element;

FIG. 10 illustrates the interaction between the restrictor and a brake shoe;

FIG. 11 illustrates the interaction between the restrictor and a spring housing counterbalance element; and

FIG. 12 illustrates the interaction between the restrictor and a block and tackle housing counterbalance element.

### DETAILED DESCRIPTION OF THE INVENTION

Although the present invention window sash restrictor system and methodology can be used on many types of double-hung windows, only a few window applications are illustrated and described. The exemplary embodiment is being shown for the purposes of explanation and description. The exemplary embodiment is selected in order to set forth one of the best modes contemplated for the invention. The illustrated embodiment, however, is merely exemplary and should not be considered as a limitation when interpreting the scope of the appended claims.

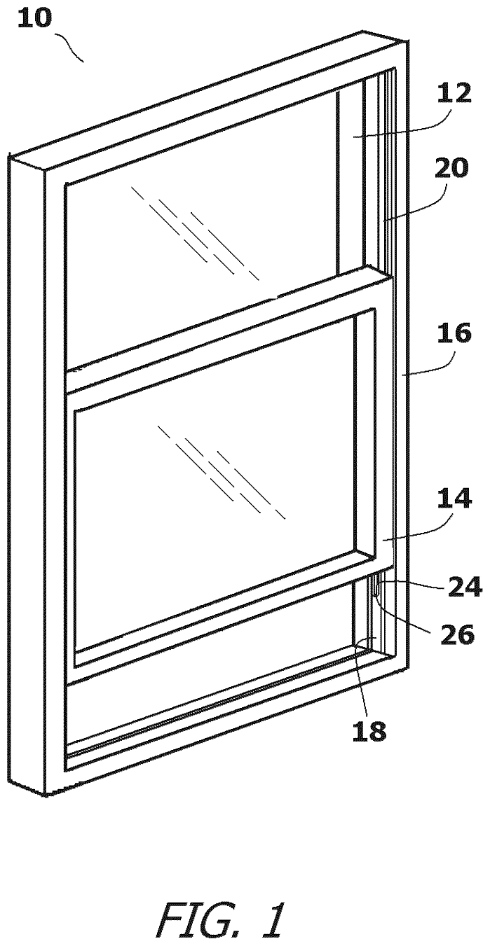

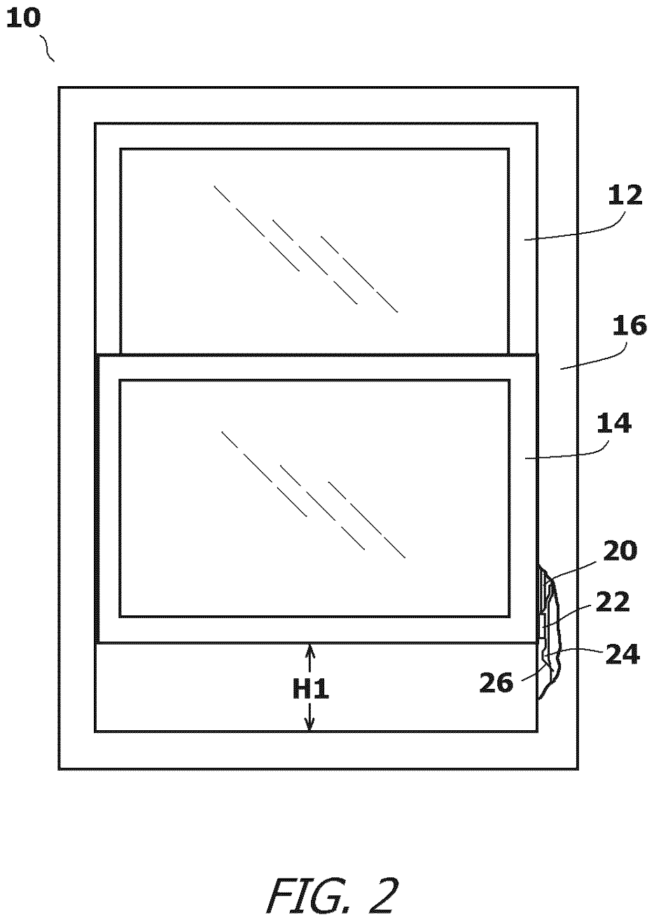

Referring to FIG. 1 in conjunction with FIG. 2, a double-hung window assembly 10 is shown. The window assembly 10 has an upper sash 12 and a lower sash 14 that are set into a window frame 16. The window frame 16 has a guide track 18 for guiding the up and down sliding motions of the upper and lower sashes 12, 14. Depending upon the type of window frame 16 in use, the guide tracks 18 can be made from extruded plastic, can be extruded metal, or can be fabricated from wood.

The lower sash 14 has a counterbalance system 20 that both assists the lower sash 14 with rising and retains the lower sash 14 in place once opened. The counterbalance system 20 can be a coil spring system or a block and tackle system, as is later described. In either scenario, the counter balance system 20 has a counterbalance element 22 that attaches to the lower sash 14 near the bottom of the lower sash 14. The counterbalance element 22 is disposed within the confines of the guide track 18 between the lower sash 14 and the window frame 16.

The present invention is a restrictor 24 that mounts to the window frame 16 within the area of the guide track 18. The restrictor 24 extends into the guide track 18 and selectively engages the counterbalance element 22 of the counter balance system 20 that is attached to the lower sash 14. The restrictor 24 engages the counter balance system 20 of the lower sash 14 when the lower sash 14 is opened to a selected height H1. The preferred height H1 is between three inches and five inches. Once the lower sash 14 is opened to the selected height H1, the restrictor 24 becomes engaged and prevents the lower sash 14 from being opened to any greater height. The restrictor 24 is positioned in the guide track 18 of the window frame 16 and has release tabs 26 that extend below the lower sash 14 when the lower sash 14 is opened to the selected height H1. When the release tabs 26 are manually engaged, the restrictor 24 disengages from the counterbalance element 22 and the lower sash 14 is free to open to its fullest extent.

Since the release tabs 26 are located in the guide tracks 18, the release tabs 26 are inconspicuous and do not detract from the aesthetics of the window sashes 12, 14. Furthermore, by being located in the guide tracks 18, the release tabs 26 are not obvious elements that would attract the attention of a curious child playing near a window. Lastly, being located in the guide tracks 18, the release tabs 26 are equally accessible from both sides of the window assembly 10. Thus, the release tabs 26 can be readily accessed by a person outside the building in case of an emergency.

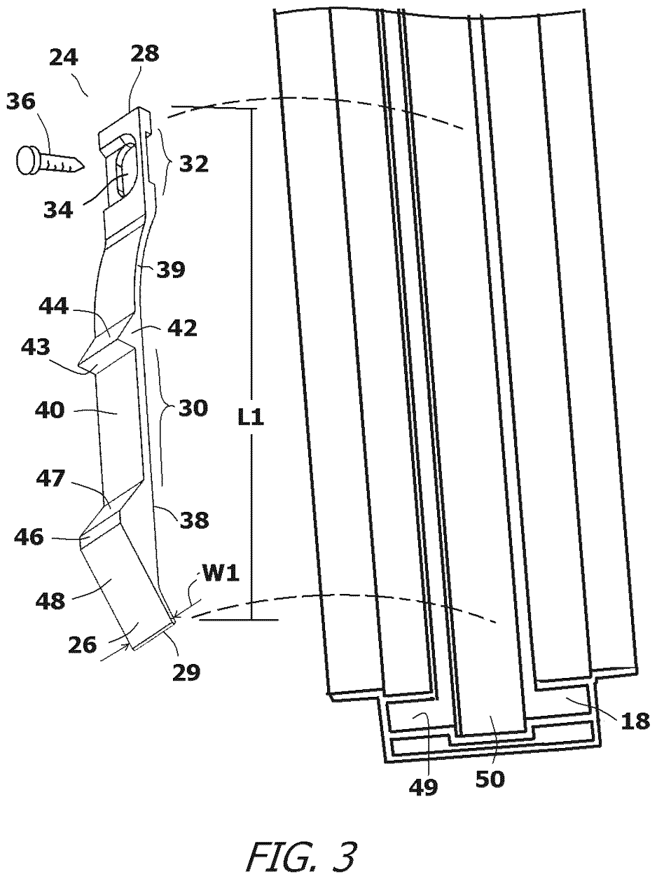

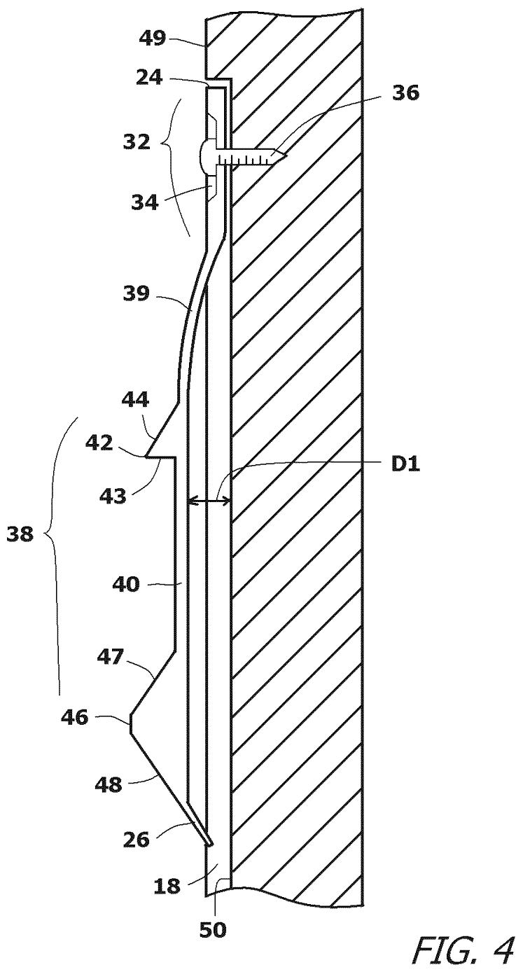

Referring to FIG. 3 and FIG. 4 in conjunction with FIG. 1 and FIG. 2, it can be seen that the restrictor 24 is a unistructurally molded element having an elongated body 30 that extends from a first end 28 to an opposite second end 29. The plastic used to mold the restrictor 24 is flexible to enable the restrictor 24 to elastically flex. When mounted into a guide track 18, the first end 28 of the elongated body 30 is mounted vertically above the second end 29. The elongated body 30 has an overall length L1 and an overall width W1.

The elongated body 30 of the restrictor 24 has a flat mounting section 32 that is located immediately adjacent the first end 28. A screw slot 34 is formed through the flat mounting section 32. The flat mounting section 32 mounts to a window frame 16 using a screw 36 that passes through the screw slot 34. The screw slot 34 is elongated for a purpose that is later described.

The release tab 26 of the restrictor 24 is at the second end 29 of the elongated body 30. The restrictor 24 has a flexible arm 38 that extends from the flat mounting section 32 to the release tab 26. The flexible arm 38 extends as a cantilever from the flat mounting section 32 and extends to an elevation that is a distance D1 from the elevation of the flat mounting section 32. The distance D1 of the flexible arm 38 is between one and five millimeters with a preferred offset of approximately two millimeters. Accordingly, it will be understood that when the flat mounting section 32 is mounted to a surface in the guide track 18, only the flat mounting section 32 touches the surface. The remainder of the restrictor 24 is suspended in the air as a cantilever at a small distance from the mounting surface.

The flexible arm 38 includes a curved segment 39 that extends away from the flat mounting section 32. The curved segment 39 flexes when the flexible arm 38 experiences a lateral force. The curved segment 39 leads into a straight segment 40. A locking protrusion 42 extends from the flexible arm 38 at the transition between the curved segment 39 and the straight segment 40. The locking protrusion 42 has a flat surface 43 that is perpendicular to the straight segment 40 and an inclined surface 44 that slopes toward the first end 28 of the elongated body 30.

The straight segment 40 extends from the locking protrusion 42 to a displacement protrusion 46. The displacement protrusion 46 has a first sloped surface 47 and an opposite second sloped surface 48. The second sloped surface 48 extends into the structure of the release tab 26 and the release tab 26 terminates at the second end 29.

The restrictor 24 mounts within the guide track 18 of the window frame 16. The guide track 18 has a rear wall 49 that faces the lower sash 14. The elongated body 30 of the restrictor 24 has a length L1 and a width W1. A recess 50 is formed into the rear wall 49 of the guide track 18. The recess 50 is sized to accommodate the elongated body 30 of the restrictor 24. The recess 50 can be molded, stamped or cut into the guide track 18 depending upon the construction materials of the guide track 18 and the overall window frame 16. The restrictor 24 is attached within the recess 50 on the rear wall 49 of the guide track 18 using the mounting screw 36. The mounting screw 36 passes into the screw slot 34 of the flat mounting section 32. Accordingly, the mounting screw 36 holds the flat mounting section 32 flush against the flat of the recess 50. However, the restrictor 24 is still free to move up and down within the range provided by the elongated screw slot 34.

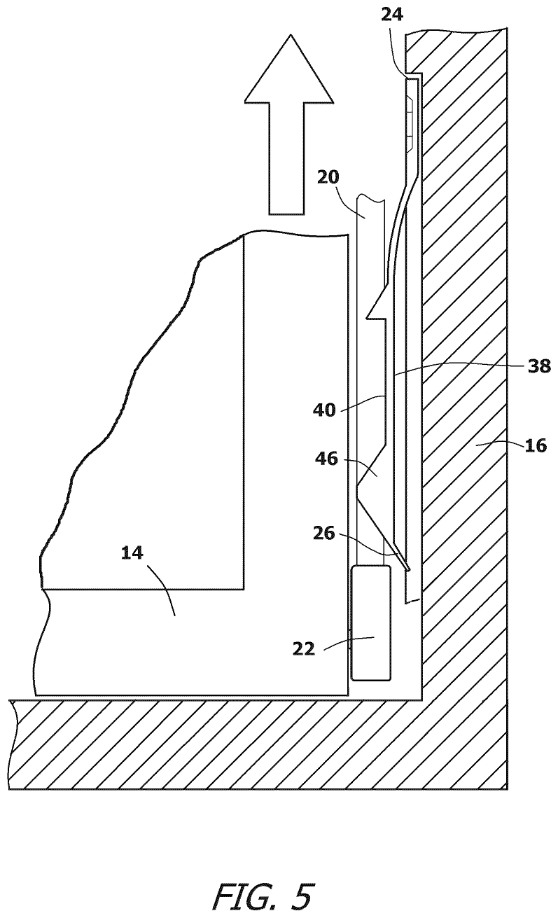

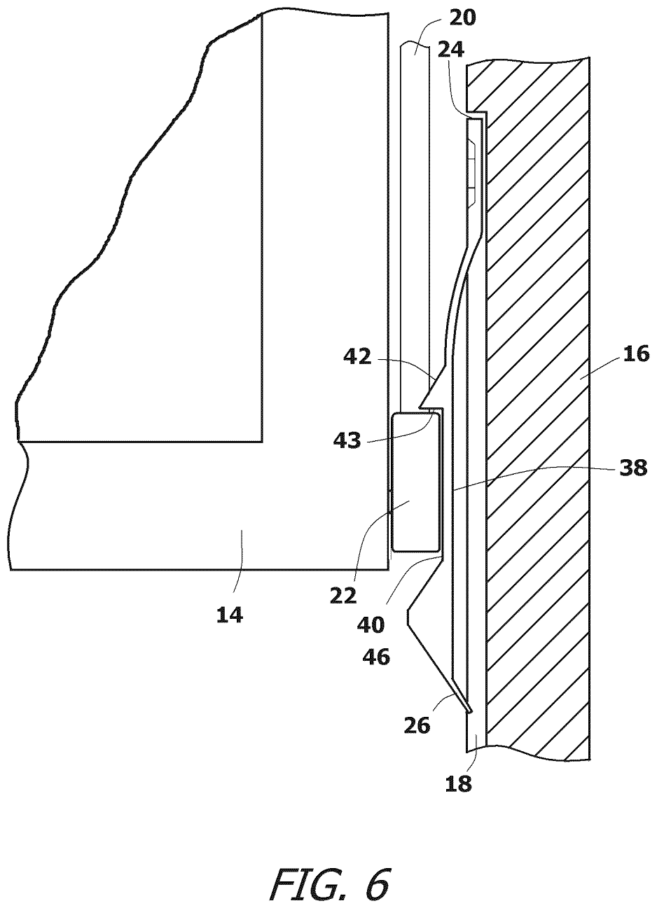

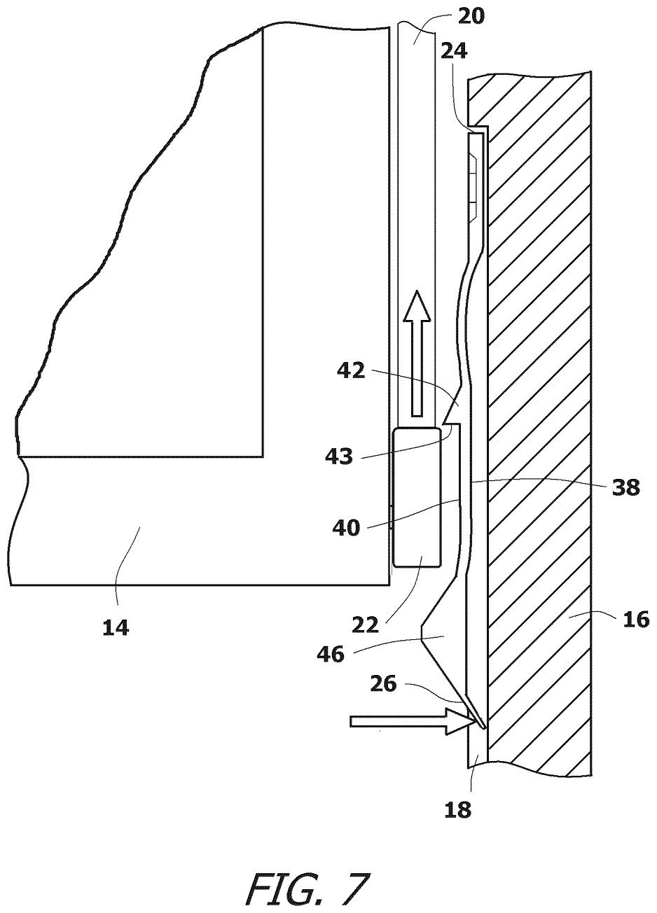

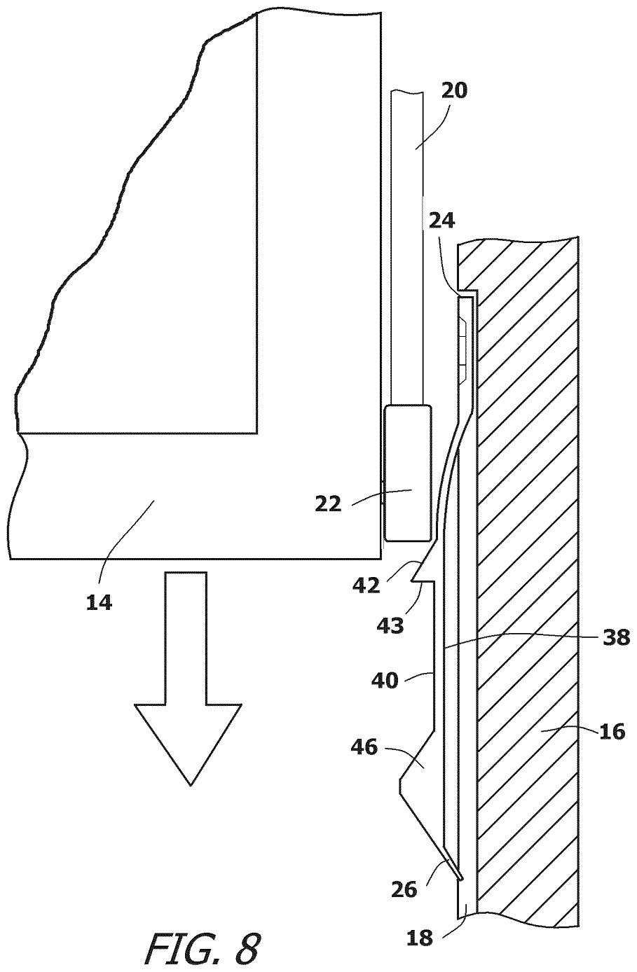

Referring to FIG. 5, FIG. 6, FIG. 7 and FIG. 8 in conjunction with FIG. 3 and FIG. 4, it can be seen that the lower sash 14 has a counterbalance system 20. The counterbalance system 20 has some counterbalance element 22 that physically attaches to the lower sash 14. Depending upon the type of window assembly 10 being used, the counterbalance element 22 can be a brake shoe, a spring mount, or a block and tackle element. Regardless, the counterbalance element 22 is connected to the lower sash 14 and moves up and down with the lower sash 14.

As the lower sash 14 is raised from a closed position, the counterbalance element 22 comes into contact with the displacement protrusion 46 of the restrictor 24. This causes the flexible arm 38 of the restrictor 24 to be displaced deeper into the guide track 18 and out of the way of the advancing counterbalance element 22. This provides the flexible arm 38 with stored spring energy. As can be seen in FIG. 6, once the counterbalance element 22 passes into the straight segment 40 of the restrictor 24, the flexible arm 38 springs back toward its original position. This drives the locking protrusion 42 into position above the counterbalance element 22. The flat surface 43 of the locking protrusion 42 faces the counterbalance element 22 and contacts the counterbalance element 22 should the lower sash 14 be raised any further. The contact prevents the lower sash 14 from being raised beyond the point of contact, therein restricting the lower sash 14 to only a partial opening. At the point of contact, the release tab 26 of the restrictor 24 extends below the lower sash 14 and is accessible in the guide track 18 of the window frame 16.

As is indicated in FIG. 7, if it is desired to open the lower sash 14 fully, a person need only press the release tab 26 on the restrictor 24 that protrudes below the lower sash 14. When the release tab 26 is pressed, the flexible arm 38 moves in toward the guide track 18. The locking protrusion 42 is displaced and moves free of the counterbalance element 22. The result is that the lower sash 14 is now free to open fully.

Referring to FIG. 8, it will be understood that once the window sash 14 is fully open, the restrictor 24 does not inhibit the sash from being closed. As the window sash 14 is closed, the counterbalance element 22 first contacts the inclined surface 44 of the locking protrusion 42. This moves the locking protrusion out of the way of the descending counterbalance element 22. As the window sash 14 continues to close, the counterbalance element 22 contacts the sloped surface 47 of the displacement protrusion 46. This moves the displacement protrusion and enables the window sash 14 to fully close without resistance and without having to manually engage the restrictor 24.

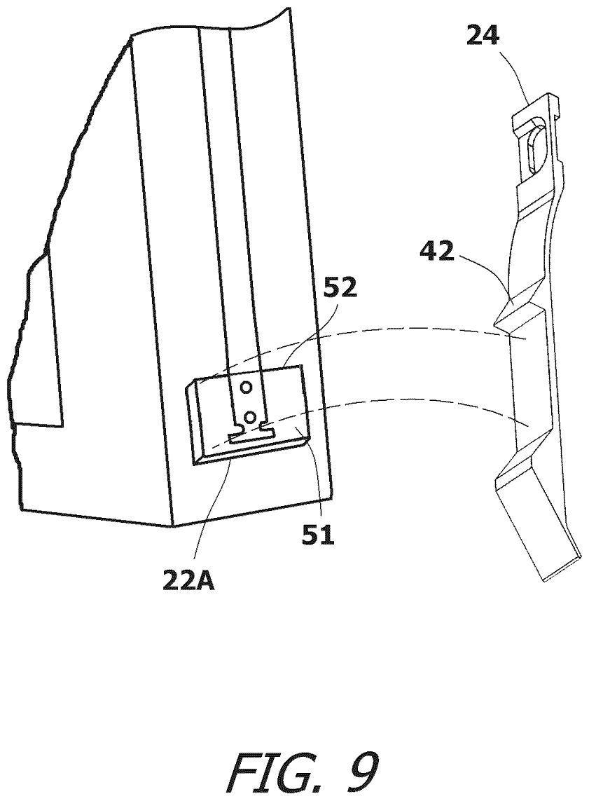

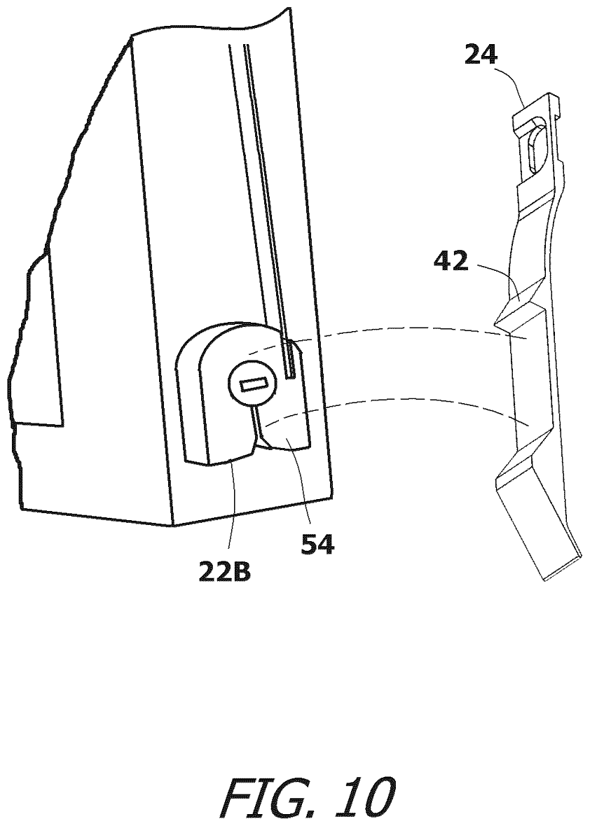

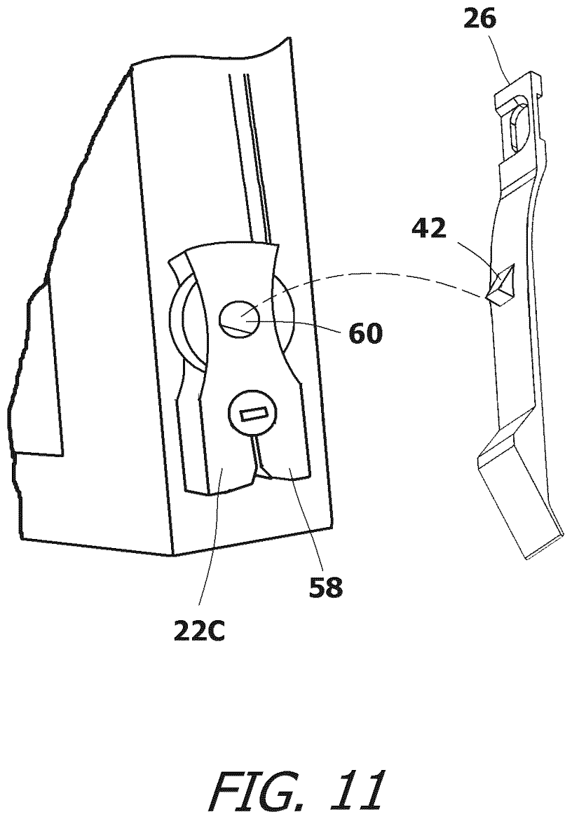

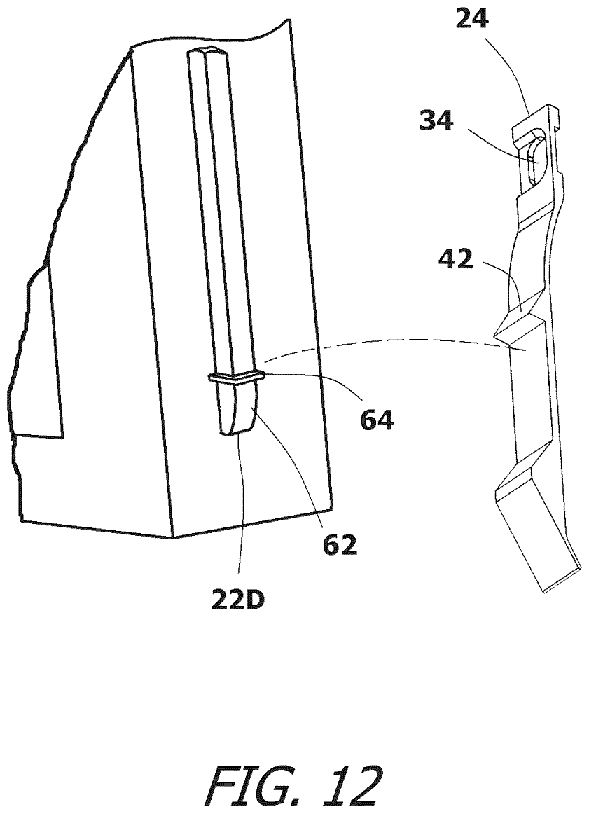

In the figures referenced above, the locking protrusion 42 is shown engaging the top of the counterbalance element 22. However, this need not be the case. The locking protrusion 42 can engage features on the top, center, or toward the bottom of the counterbalance element 22 depending upon the counterbalance system 20 being used. Referring to FIG. 9, it can be seen that if the counterbalance element 22A is a simple spring anchor 51, the locking protrusion 42 can contact the top surface 52 of the spring anchor 51. Referring to FIG. 10, it can be seen that if the counterbalance element 22B is a brake shoe 54, the locking protrusion 42 can engage any the top of the brake shoe 22B or any present on the brake shoe 54. Referring to FIG. 11, it can be seen that if the counterbalance element 22C is a shoe and spring housing 58, the locking protrusion 42 can engage the open center of any spring hub 60. Lastly, referring to FIG. 12, it can be seen that if the counterbalance element 22D is a block and tackle assembly 62, the locking protrusion 42 can engage the head flange 64 of the block and tackle assembly 62. In some applications, the locking protrusion 42 may need to be both depressed and moved vertically to fully disengage the counterbalance element 22. Since the restrictor 24 is mounted with a screw 36 in a slot 34, the restrictor 24 is free to move up and down in a limited range. This movement is sufficient to disengage the locking protrusion 42 from any common counterbalance element 22.

It will be further understood that although the present invention is being described in an application that prevents a lower sash from being raised fully, the present invention can also be used to keep an upper sash from being lowered fully by placing inverted restrictors in the guide tracks of the upper sash. Furthermore, each sash in a window assembly can be provided with either one restrictor or two restrictors, depending upon the window design of the manufacturer.

It will be understood that the embodiment of the present invention that is illustrated and described is merely exemplary and that a person skilled in the art can make many variations to that embodiment. All such embodiments are intended to be included within the scope of the present invention as defined by the claims.

1. A method of restricting a movement of a window sash in a guide track of a window assembly, wherein said guide track has a rear wall that faces said window sash, and wherein said window assembly has a counterbalance system and said window sash has a counterbalance element that connects said window sash to said counterbalance system, said method comprising:
providing a restrictor having a flexible arm and a locking protrusion on a said flexible arm;
providing a recess in said rear wall of said guide track, wherein said recess is sized to receive said restrictor; and
mounting said restrictor within said recess, wherein said flexible arm biases said locking protrusion away from said recess and toward said window sash, wherein said counterbalance element biases said flexible arm toward said recess when said window sash is in a fully closed position, and wherein said locking protrusion engages said counterbalance element on said window sash as said window sash is moved in said guide track from a said fully closed position toward a fully open position, therein preventing said window sash from reaching said fully open position.

2. The method according to claim 1, wherein said restrictor has a flat section and said flexible arm extends from said flat section, wherein mounting said restrictor within said recess includes attaching said flat section within said recess with a screw.

3. The method according to claim 2, wherein said flexible arm terminates with a release tab that extends below said window sash when said counterbalance element is engaged by said locking protrusion.

4. The method according to claim 3, further including pressing said release tab to displace said flexible arm into said recess and disengage said locking protrusion from said counterbalance element.

5. The method according to claim 1, wherein said counterbalance element is selected from a group consisting of spring mounts, brake shoes, spring housings and block and tackle housings.

6. The method according to claim 2, wherein mounting said restrictor within said recess includes providing a slot in said flat section of said restrictor wherein said screw passes through said slot and enables said flat section to move relative to said screw while being connected within said recess by said screw.

7. (canceled)

8. The method according to claim 3, wherein said flexible arm has a curved segment that extends from said flat section to said locking protrusion and a straight segment that extends from said locking protrusion toward said release tab.

9. In a double-hung window assembly having a window sash that moves in a guide track between a fully closed position and a fully open position, wherein said guide track has a rear wall that faces said window sash, a method of restricting said window sash comprising:
providing a restrictor having flexible arm and a locking protrusion on said flexible arm;
providing a recess in said rear wall of said guide track; and
mounting said restrictor within said recess, wherein said flexible arm biases said locking protrusion out of said recess toward said window sash, wherein said locking protrusion engages an element on said window sash as said window sash is moved in said guide track from said fully closed position toward said fully open position, therein preventing said window sash from reaching said fully open position, and wherein said element biases said flexible arm into said recess when said window sash is in said fully closed position.

10. The method of restricting the window sash according to claim 9, wherein the window assembly has a counterbalance system and said element on said window sash connects said window sash to said counterbalance system.

11. The method of restricting the window sash restricting the window sash according to claim 9, wherein said restrictor has a flat section and said flexible arm extends from said flat section, wherein mounting said restrictor within said includes attaching said flat section within said recess.

12. The method of restricting the window sash according to claim 11, wherein said flexible arm terminates with a release tab that extends below said window sash when said element is engaged by said locking protrusion.

13. The method of restricting the window sash according to claim 12, further including pressing said release tab to displace said flexible arm into said recess and disengage said locking protrusion from said element on said window sash.

14. The method of restricting the window sash according to claim 10, wherein said element is selected from a group consisting of spring mounts, brake shoes, spring housings and block and tackle housings.

15. The method of restricting the window sash according to claim 11, wherein mounting said restrictor within said recess includes providing a slot in said flat section of said restrictor and connecting said restrictor to said guide track with a screw that passes through said slot, wherein said slot enables said flat section to move relative to said screw while being attached within said recess by said screw.

16. (canceled)

17. The method of restricting the window sash according to claim 11, wherein said flexible arm has a curved segment that extends from said flat section to said locking protrusion and a straight segment that extends from said locking protrusion toward said release tab.

18. A restrictor for restricting a range of movement of a window sash in a double-hung window assembly, said restrictor comprising:
an elongated body unistructurally molded from plastic having a first end and an opposite second end, a flat section adjacent said first end and a flexible arm that extends from said flat section toward said second end, wherein said flexible arm has a curved segment leading from said flat section toward a straight segment;
a slotted mounting hole formed through said flat section;
a locking protrusion extending from said flexible arm between said curved segment and said straight segment; and
a displacement protrusion positioned between said straight segment and said second end, wherein said displacement protrusion has a first sloped surface facing said straight segment and an opposite second sloped surface facing said second end.

19. The restrictor according to claim 18, wherein said second end of said elongated body terminates with a release tab.

20. The restrictor according to claim 18, wherein said locking protrusion has a flat surface that is perpendicular to said straight segment.
